(19) United States
(12) Patent Application Publication
(10) Pub. No.: US 2026/0219419 A1
(43) Pub. Date: Jul. 30, 2026

(54) METHODS AND SYSTEMS FOR DETERMINING A CHARACTERISTIC OF A SURFACE

(71) Applicant: SAUDI ARABIAN OIL COMPANY, Dhahran (SA)

(72) Inventors: Salem A. Alturky, Dhahran (SA); Tarik A. Bangash, Dhahran (SA); Mohammed S. Alfarhan, Dhahran (SA); Jarvis R. Cline, Al Khobar (SA); Saeed A. Dobas, Dhahran (SA)

(73) Assignee: SAUDI ARABIAN OIL COMPANY, Dhahran (SA)

(21) Appl. No.: 19/040,284

(22) Filed: Jan. 29, 2025

(51) Int. Cl. G01V 20/00; G01S 7/497; G01S 17/89; G01V 8/12

(52) U.S. Cl. CPC G01V 20/00; G01S 7/497; G01S 17/89; G01V 8/12

(57) ABSTRACT

Methods and systems are disclosed herein. A method for determining a characteristic of a surface includes calibrating an imaging device to a surface. The method includes capturing a lens distortion parameter, capturing an image of the surface, displaying the image, identifying a plurality of tie points on the image, and capturing a plurality of location coordinates of a point marker located on the surface. The method may include calculating a plurality of transformation parameters, identifying an additional point marker located on the surface, capturing an additional plurality of location coordinates of the additional point marker, plotting a plot point on the image automatically transformed from the additional point marker, and calculating a feature of the surface.

### BACKGROUND

Structural geology may be used to aid in understanding geological structures, developing construction plans, conducting hazard assessments, managing environmental issues, and exploiting mineral and energy resources. Geologists and survey engineers have traditionally used Brunton compasses or other geologic tools to extract geological and/or structural information, such as structural/geologic features (Strike/Dip/Trend/Plunge/Co-axial Plane/etc.). However, these tools are limited in their ability to measure geological surfaces and/or structural information in difficult-to-reach areas, such as cliffs with steep angles and other dangerous areas.

### SUMMARY

This summary is provided to introduce a selection of concepts that are further described below in the detailed description. This summary is not intended to identify key or essential characteristics and/or items of the claimed subject matter, nor is it intended to be used as an aid in limiting the scope of the claimed subject matter.

In some aspects, the techniques described herein relate to a method for determining a characteristic of a surface, including calibrating an imaging device to the surface. The method may include capturing a lens distortion parameter from an imaging device. The method may include capturing an image of the surface. The method may include displaying the image on a display. The method may include identifying a plurality of tie points on the image. For each tie point, the method may include capturing a plurality of location coordinates of a point marker located on the surface. The method may include calculating a plurality of transformation parameters. The method may include identifying an additional point marker located on the surface. The method may include capturing an additional plurality of location coordinates of the additional point marker. The method may include plotting a plot point on the image automatically transformed from the additional point marker using the plurality of transformation parameters. The method may include calculating a feature of the surface based on the plurality of tie points and the plot point.

In some aspects, the techniques described herein relate to a system for determining a characteristic of a surface. The system includes an imaging device, a positioning device, and a feature analysis system. The imaging device is configured to capture an image of the surface. The imaging device is calibrated to the surface. The imaging device includes a lens and a lens distortion parameter. The positioning device is configured to, for each tie point, capture a plurality of location coordinates of a point marker located on the surface using a positioning device that is calibrated to the imaging device, and capture an additional plurality of location coordinates of an additional point marker. The feature analysis system is configured to display the image and identify a plurality of tie points on the image. For each tie point, the feature analysis system is configured to calculate a plurality of transformation parameters. The feature analysis system is configured to identify an additional point marker located on the surface, plot a plot point on the image automatically transformed from the additional point marker, and calculate a feature of the surface based on the plurality of tie points and the plot point.

Other aspects and advantages of the claimed subject matter will be apparent from the following description and the appended claims.

### BRIEF DESCRIPTION OF DRAWINGS

Specific embodiments of the disclosed technology will now be described in detail with reference to the accompanying figures. Like elements in the various figures are denoted by like reference numerals for consistency.

FIG. 1A depicts an example surface from which a surface analysis system acquires collection data that may be used to determine a feature in accordance with one or more embodiments.

FIG. 1B depicts an example surface from which a surface analysis system acquires collection data that may be used to determine a feature in accordance with one or more embodiments.

FIG. 2A depicts an example illustration showing a concept of simulated perspective-projection that may be used by an imaging device to capture an image of a surface.

FIG. 2B depicts a schematic of a feature analysis system in accordance with one or more embodiments.

FIG. 3A depicts an example image captured of an example outcrop using the surface analysis system in accordance with one or more embodiments.

FIG. 3B depicts an example image captured of an example outcrop using the surface analysis system in accordance with one or more embodiments.

FIG. 4 is a flowchart depicting a method for determining a feature in accordance with one or more embodiments.

FIG. 5 illustrates a computer system that may be used in relation to various embodiments.

FIG. 6 depicts an example construction system performing an example construction operation according to a construction plan based on a feature and developed at least in part by a construction planning system in accordance with one or more embodiments.

FIG. 7 depicts an example drilling system performing an example drilling operation according to a well drilling plan based on a feature and developed at least in part by a well planning system in accordance with one or more embodiments.

### DETAILED DESCRIPTION

In the following detailed description of embodiments of the disclosure, numerous specific details are set forth in order to provide a more thorough understanding of the disclosure. However, it will be apparent to one of ordinary skill in the art that the disclosure may be practiced without these specific details. In other instances, well-known features have not been described in detail to avoid unnecessarily complicating the description.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as using the terms “before,” “after,” “single,” and other such terminology. Rather, the use of ordinal numbers is to distinguish between the elements. By way of an example, a first element is distinct from a second element, and the first element may encompass more than one element and succeed (or precede) the second element in an ordering of elements.

It is to be understood that the singular articles “a,” “an,” and “the” include plural referents unless the context clearly dictates otherwise. Thus, for example, reference to “a fluid sample” includes reference to one or more of such samples.

Terms such as “approximately,” “substantially,” etc., mean that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

It is to be understood that one or more of the steps shown in the flowchart may be omitted, repeated, and/or performed in a different order than the order shown. Accordingly, the scope disclosed herein should not be considered limited to the specific arrangement of steps shown in the flowchart.

Although multiple dependent claims are not introduced, it would be apparent to one of ordinary skill that the subject matter of the dependent claims of one or more embodiments may be combined with other dependent claims.

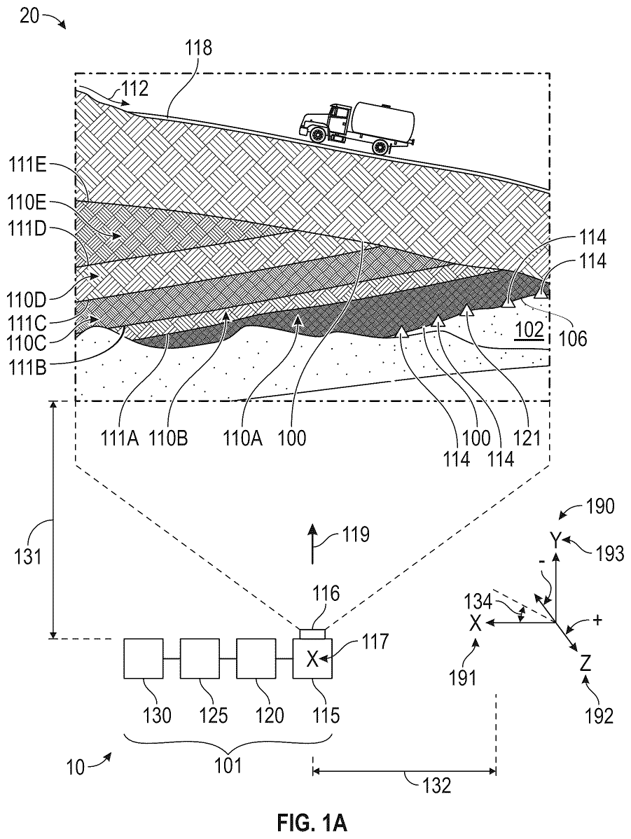

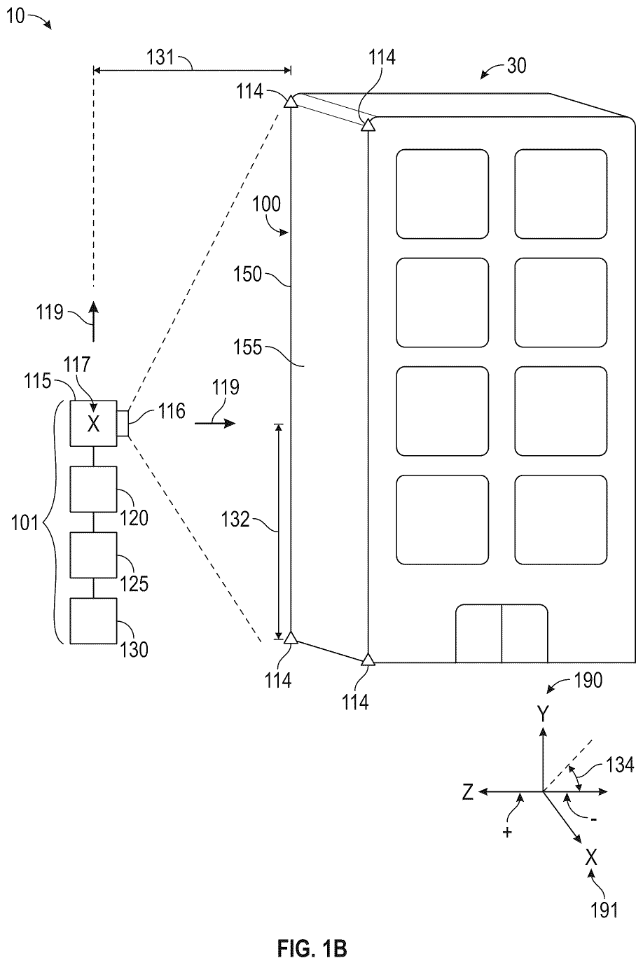

In the following description of FIGS. 1-7, any component described with regard to a figure, in various embodiments disclosed herein, may be equivalent to one or more like-named components described with regard to any other figure. For brevity, descriptions of these components will not be repeated with regard to each figure. Thus, each and every embodiment of the components of each figure is incorporated by reference and assumed to be optionally present within every other figure having one or more like-named components. Additionally, in accordance with various embodiments disclosed herein, any description of the components of a figure is to be interpreted as an optional embodiment which may be implemented in addition to, in conjunction with, or in place of the embodiments described with regard to a corresponding like-named component in any other figure.

For purposes of this disclosure, a “surface,” in some embodiments, may be a natural (i.e., geologic) surface that may be located on a rock outcrop, a cliff, hill, mountain and the like that includes an exposure of one or more layers of rock and/or one or more geologic formations. In some embodiments, the surface may be located on a man-made structure such as any structural building, a bridge, a road, and the like. The surface may have a thickness and a volume. Characteristics of the surface may include features as described below, rock and/or material type, and rock and/or material properties as known to those skilled in the art.

For purposes of this disclosure, a “feature” may be any spatial descriptor such as an orientation (e.g., strike, dip, plunge, and/or trend), length, area, volume, and the like that describes a surface. In some embodiments, the feature may be a spatial descriptor for a linear component of the surface such as a geologic fault or edge of a building, bridge, and/or road. In some embodiments, the feature may be a spatial descriptor for a surface such as a bedding surface of a geologic bed of sedimentary rock, a geologic formation or a face of a building, bridge, and/or road. The feature may be digitally represented by a line or a polygon. The feature may include areal and volumetric properties that describe a surface. In some embodiments, the feature may be an idealized representation, i.e., a geological interface as a truly planar surface. When viewed on a fine enough scale, there are always bumps, grooves, cracks, undulations, etc. It will be apparent to one skilled in the art that on the appropriate scale, the feature may be efficiently approximated by a geometrical plane.

Methods and systems for determining a characteristic, such as a feature, of a surface are provided herein. The method may include calibrating an imaging device to the surface. In some embodiments, the surface may be a geological fault, or a geologic bed and/or formation, at least a portion of which is exposed. In some embodiments, the surface may be components of a manmade structure such as a face or edge of a building. The method may include capturing a lens distortion parameter from an imaging device such as a camera. The method may include capturing, using the imaging device, an image of the surface. The method may include displaying the image on a display. The method may include identifying a plurality of tie points on the image. For each tie point, the method may include capturing one or more location coordinates of a point marker located on the surface using a positioning device that is calibrated to the imaging device and calculating a plurality of transformation parameters. In some embodiments, the positioning device may be a laser range finder. The method may include identifying an additional point marker located on the surface. The method may include capturing an additional location coordinate of the additional point marker. The method may include plotting a plot point on the image automatically transformed from the additional point marker using the transformation parameters. The method may include calculating a feature of the surface based on the plurality of tie points and the plot point.

The methods and system disclosed herein provides geologists and survey engineers working in the field with ability to remotely calculate a feature such as the strike, dip, trend, plunge, co-axial plane, and other features of any geologic or man-made structures that include a surface. The feature may be an orientation of the surface that may include a combination of several features such as strike and dip in order to describe the orientation. The methods and systems provide real-time mapping (or offline mapping) of point measurements by an imaging and positioning device on a surface to their proper location on an image taken for that location. Collection data may include measurements of, but are not limited to, structural geology and sedimentology features and/or man-made structures. Features may be calculated after processing data and/or in real-time.

FIG. 1A depicts an example surface (100), located at a collection site (10), from which a surface analysis system (101) acquires collection data (125) in accordance with one or more embodiments. In some embodiments, the surface (100) may be part of an outcrop (20), which may include a pre-existing basement rock (102). This basement rock (102) may be an igneous rock, a metamorphic rock, or may be a preexisting sedimentary rock. In some embodiments, the basement rock (102) may be divided into a first basement rock and a second basement rock separated by a geologic fault (106). The first basement rock and a second basement rock may be of the same rock type, or the first basement rock and the second basement rock may be of different rock types.

For example, the outcrop (20) may be remnants of a sedimentary basin that resulted from flows of sediment (112) originating in surrounding regions that accumulated on a ground surface (118) of the sedimentary basin. The ground surface (118) of the sedimentary basin may be below sea level, in which case the sedimentary basin may be filled with seawater. In other cases, the ground surface (118) of the sedimentary basin may be partially or wholly occupied by a lake or by a river system, or by any combination of river, lake, and sea. At the archaic time, the sedimentary basin may be filled by a plurality of sedimentary layers (110A, 110B, 110C, 110D, 110E) deposited at earlier times during the creation and earlier history of the sedimentary basin. Different types of rock layers may be created by different environmental conditions during their deposition. For example, without limitation, fine-grained mudstone may be deposited in deep water, sandstone with uniform grain sizes may be deposited in beach or shallow water environments, shales or coals may be deposited in marsh or swamp environments, and coarse-grained conglomerates may be deposited in fast-flowing river environments.

Different types of rock may have different petrophysical and geomechanical rock properties at the time they are deposited. Even rock categorized as the same, such as sandstone, may have petrophysical and geomechanical properties that differ from other samples of the same type. For example, one sandstone may have 40% porosity while another sandstone may have only 26% porosity. Petrophysical properties may include, without limitation, porosity, permeability, and total organic content. Geomechanical properties may include, without limitation, Young's modulus, Poisson's ratio, bulk modulus, compaction coefficient and friction angle.

Over a geological timescale a sedimentary basin may evolve. In particular, a sedimentary basin may deepen, and additional sedimentary layers may be deposited above those that existed before shown in FIG. 1A. For example, the sedimentary basin may deepen because the underlying basement blocks may be pulled apart from one another by tectonic forces, or the basement rocks may cool causing their density to increase and the basement rocks to settle deeper. In such cases, the flows of sediment into the sedimentary basin may deposit additional sedimentary layers burying the archaic sedimentary layers to greater depths and compressing them under greater pressures. For example, sedimentary layer (110A) may be deposited first with sedimentary layers (110B, 110C, 110D, 110E) being deposited in succession over geologic time.

Each sedimentary layer (110A, 110B, 110C, 110D, 110E) may be bounded by one or more subterranean boundaries (111A, 111B, 111C, 111D, 111E) which may also be known as geologic surfaces. A geologic surface may be representative of a change in rock type, rock content, or other changes in characteristics (i.e., rock properties) of the layer that is well known in the art. The geologic surfaces may bound a layer of rock that may include rock of similar characteristics or rock properties. The geologic surfaces may also bound a formation that includes one or more layers of rock, for example, beds of sedimentary rock. In accordance with one or more embodiments, the surface (100) may include, but is not limited to, a geologic fault such as the geologic fault (106) and/or geologic surfaces such as the geologic surfaces (111A, 111B, 111C, 111D, 111E).

In accordance with one or more embodiments, one or more point markers (114) and one or more additional point markers (121) may be identified on the outcrop along the surface (100). The point markers (114) may be identified with a structural aspect of the outcrop, for example, a geologic structure such as the geologic fault (106) or a geologic surface such as the geologic surfaces (111A, 111B, 111C, 111D, 111E) depicted in FIG. 1A. In some embodiments, the surface (100) may visibly appear as a curvilinear boundary between two or more beds of rock or fault blocks. In some embodiments, the surface (100) may be an exposed geologic surface of a bed of rock. In some embodiments, the point markers (114) may be identified with various locations around the outcrop.

In accordance with one or more embodiments, the surface analysis system (101) includes an imaging device (115), a positioning device (120), a feature analysis system (130) and one or more coordinate systems (e.g., a world coordinate system (190), a device coordinate system, an image coordinate system, and/or a sensor coordinate system). The coordinate system may be a three-dimensional (“3D”) coordinate system (e.g., the world coordinate system (190) and/or the device coordinate system). In some embodiments, the coordinate system may be a two-dimensional (“2D”) coordinate system (e.g., the sensor coordinate system, and/or the image coordinate system).

In some embodiments, the imaging device (115) includes one or more lenses (116) and an image sensor. The arrangement of the imaging device (115) may determine one or more directional vectors (119) (e.g., a forward vector of the imaging device (115) relative to the configuration of the lens (116) and an image sensor and/or an up vector of the imaging device (115) relative to the ground surface (118) or a horizontal plane). The imaging device (115) may be a camera such as a high-resolution camera. Based upon the disclosure provided herein, one of ordinary skill in the art will recognize a variety of lenses and configurations of imaging devices and lenses that are possible in accordance with one or more embodiments. For example, the lens (116) may be chosen to enhance resolution or to maximize angle view such as a wide-angle lens. Typical imaging devices for mapping a geologic surface that use lenses may include a resolution of 1.3 megapixels which may not have sufficient resolution. The methods and systems provided herein allow for lenses that may include resolution, for example, of up to 100 megapixels, or more. For example, the imaging device may be a 50-megapixel camera with 105 mm lens. Such imaging equipment will yield a resolution of 4 mm per pixel at a distance of 100 meters from the target.

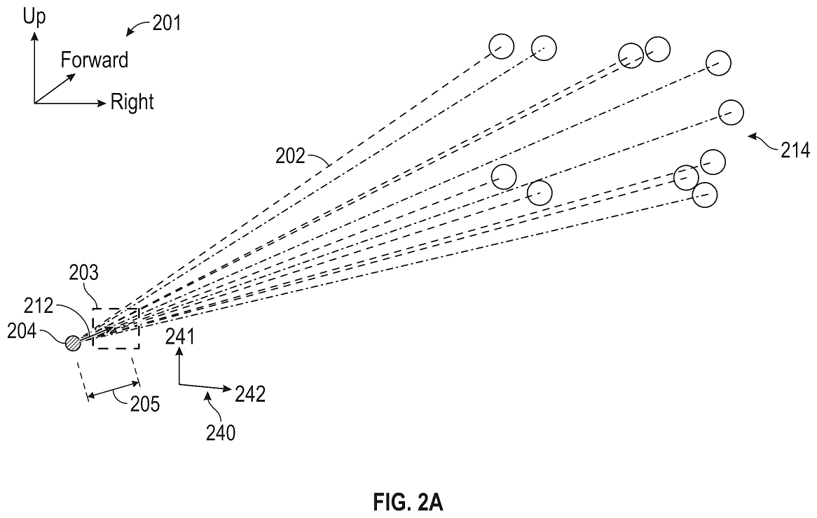

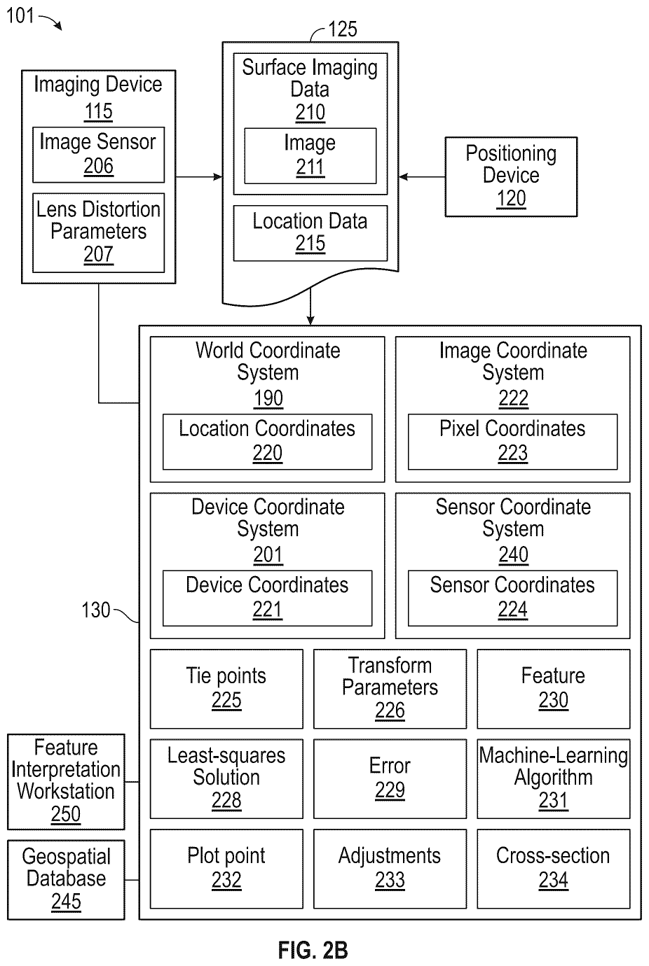

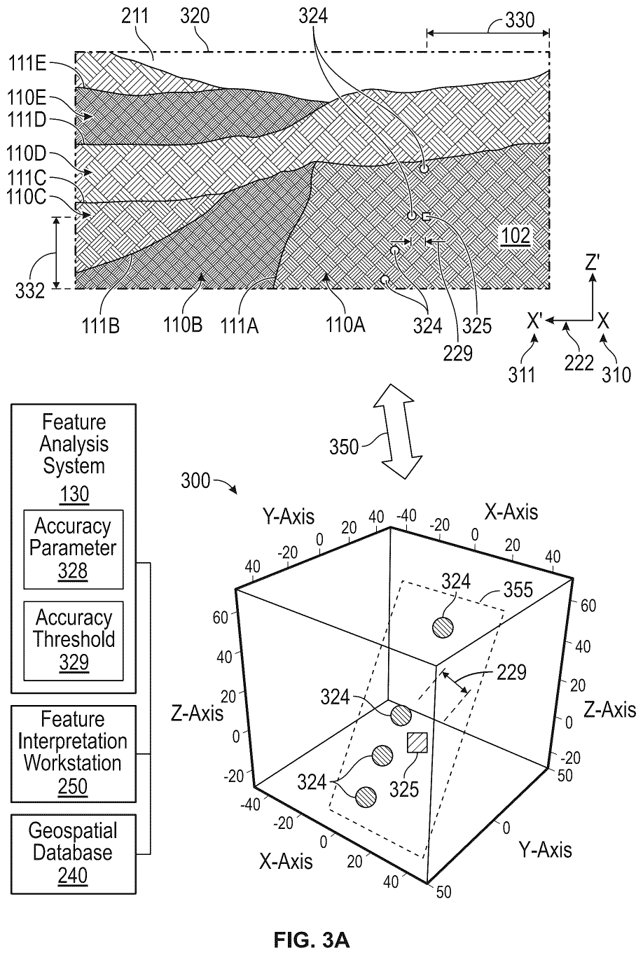

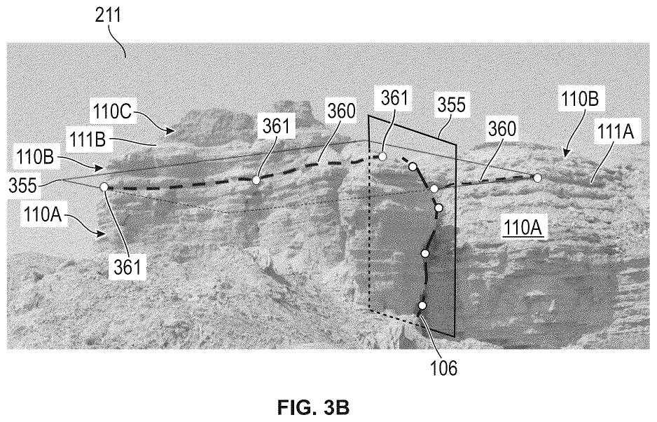

In some embodiments, the imaging device (115) may include one or more cameras, one or more image sensors, and various other sensors for acquiring the collection data (125) of the surface (100). In particular, imaging devices may include smart network devices, waterproof devices, wired devices, and/or wireless devices disposed at different locations around and on the surface (100). In some embodiments, the imaging device (115) may include a global positioning system (GPS) and may be communicably coupled to the positioning device (120) and/or the feature analysis system (130). As such, the imaging device (115) may include a hardware processor, a memory, and/or a communication interface, such as a wired or wireless communication interface. Likewise, imaging devices may acquire images such as image (211) as described in relation to FIG. 2B and FIGS. 3A-3B. In some embodiments, images may be acquired in a visible light spectrum as well as infrared images, gamma ray images, CT scans, x-ray scans, etc. In some embodiments, the imaging device (115) and the positioning device (120) may be integrated into a single data collection device (not shown).

In accordance with one or more embodiments, the imaging device (115) is configured to capture imaging data such as an image of the surface (100). The imaging device (115) may be calibrated to the surface (100). The imaging device (115) may be calibrated to the surface (100) using the positioning device (120). The positioning device (120) is configured to capture location data (e.g., location distances and directional vectors) in order for calibrating the imaging device (115) to the surface (100). The location data may be used to determine one or more location coordinates which may represent point markers (114) located on the surface (100) relative to an origin (e.g., a reference point calibrated to a governmental survey system or located by a GPS). The positioning device (120) may be calibrated to the imaging device (115) and/or to the surface (100).

In regard to collection data, the collection data (125) may include surface imaging data, location data, and/or positioning data. Surface imaging data may include an image, an image frame, a stream of image frames, and/or a portion of an image such as a specific region of the surface (100). Surface imaging data may be processed to improve visualization of the surface (100). Location data may include straightforward distances (131), traverse distances (132), elevations (134), and the directional vectors (119) of various components of the surface analysis system (101). In some embodiments, collection data (125) may be captured of a portion of the surface (100) within a target area. In some embodiments, traverse distances may refer to “horizontal” distances in relation to the imaging device (115) and the directional vectors (119) and may be parallel to the ground surface (118) and/or a geodetic surface. In some embodiments, traverse distances may be defined in reference to a coordinate system (e.g., the world coordinate system (190)) and may run parallel to an axis (e.g., X-axis).

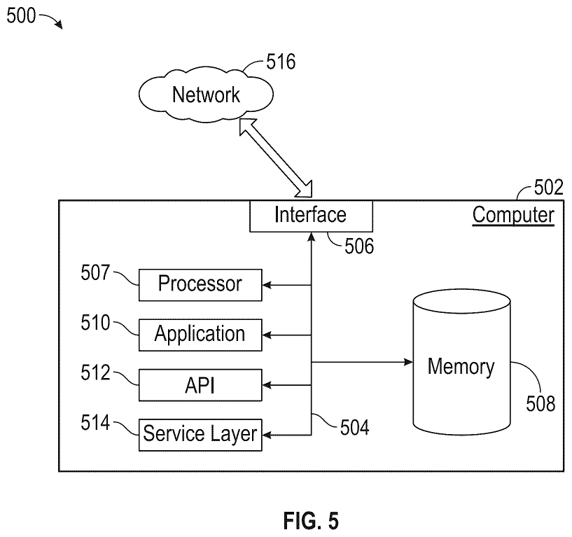

In some embodiments, the feature analysis system (130) may collect the collection data (125) over a wired or wireless network such as a network as described in relation to FIG. 5. For example, the feature analysis system (130) may use an Internet of things (IoT) platform disposed at the outcrop to acquire the collection data (125) from various IoT devices in network communication with the feature analysis system (130). The imaging device (115) may include a processor similar to the processor (507) described below in FIG. 5 and accompanying description.

In some embodiments, the positioning device (120) is configured to collect location data. For example, the positioning device (120) may be a laser range finder configured to measure various distances and positioning data about the surface (100) and various components of the surface analysis system (101). In some embodiments, the positioning device (120) may include a global positioning system (GPS) and may be communicably coupled to the imaging device (115). The positioning device (120) may be calibrated to the imaging device (115). For example, the positioning device (120) may be calibrated, using the coordinate system (e.g., a world coordinate system (190)), to the imaging device (115) either through manually measuring a position of the positioning device (120) in relation to the imaging device (115) or the positioning device (120) may relay positioning data from the GPS to the imaging device (115) and/or the feature analysis system (130). Manually measuring the position of the positioning device (120) may include measuring the physical distance from the imaging device (115), the elevation difference between the devices, and the azimuth of the positioning device (120) in relation to the imaging device (115) and a reference axis such as true north or magnetic north. The positioning device (120) may be configured to determine one or more distances to the surface (100).

In some embodiments, the positioning device (120) includes a transmitter for emitting a signal and a receiver configured to receive at least a portion of the signal. In some embodiments, the receiver may be positioned remotely such as positioned on the surface (100). In some embodiments, the receiver may be integrated into the positioning device (120). For example, the positioning device (120) may be a laser range finder. The laser range finder transmitters will transmit laser signals toward any object such as the surface (100) that the transmitter is directed toward. In embodiments with the receiver positioned separately from the transmitter, the receiver will receive a portion of the laser signal and determine location data based on the portion of the laser signal that is received by the receiver. The receiver is communicably coupled with the transmitter and is configured to communicate the collection data (125) to a user interface.

In some embodiments, the user interface may be integrated with the transmitter into the positioning device (120). If the receiver is integrated with the transmitter to form a single unit of the positioning device (120), the transmitter transmits the laser signals in the direction that the laser range finder is arranged such as toward the surface (100). The laser signals may backscatter after striking the surface (100) and the receiver may receive a portion of the laser signals that are backscattered. The laser range finder may determine location data based on a portion of the laser signals that are backscattered. In some embodiments, the positioning device (120) may be configured to measure vertical distances (e.g., elevations relative to a ground surface) and traverse distances in relation to a reference point, for example the imaging device (115). Measuring vertical distances and traverse distances may include measuring an angle of the positioning device (120) in relation to a reference axis such as true north or magnetic north.

In regard to coordinate systems, a coordinate system (e.g., world coordinate system (190), the device coordinate system, the image coordinate system, and/or the sensor coordinate system), may be, but not limited to, a Euclidean coordinate system, a cylindrical coordinate system, or a polar coordinate system. The coordinate system may include one or more spatial dimensions within different systems (e.g., a real-world system, and/or an image system). In some embodiments, the world coordinate system (190) may be used in reference to the position of the surface (100), within a real-world system, in regard to a reference axis such as true or magnetic north. The image coordinate system may be used in reference to the position and direction of the imaging device (115), within an image system, as defined by the one or more directional vectors (119).

In some embodiments, the coordinate system, such as the world coordinate system (190), may include an origin (117) and one or more coordinate axes (191, 192, 193) to represent the one or more spatial dimensions. Each coordinate axes may include a “negative” portion (−) and a “positive” portion (+) in relation to the origin (117), where the negative portion of the coordinate axes is directly opposite of the positive portion with the origin (117) disposed between each portion. Any point (e.g., tie points, point markers, and/or plot points) and/or grid cell around the coordinate axes (191, 192, 193) can be located by the one or more spatial dimensions.

For example, the world coordinate system (190) may include a right-handed system. The right-handed system may be defined where the negative portion (−) of the Z-axis represents increasing depth into the world as seen in an image, where the positive portion (+) of the Z-axis proceeds in a direction of the world that is opposite to the direction of the forward view of the imaging device (115), (i.e., the imaging device (115) is looking along and towards the negative portion of the Z-axis).

For example, a Euclidean coordinate system may have an origin that coincides with the position of the imaging device (115) and the one or more coordinate axes may include an X-axis (191), a Y-axis (192), and a Z-axis (193) that may be segmented using, for example, a metric system or an imperial system of measurement. Any point around the coordinate system (e.g., positions of various components of the surface analysis system (101)) may be located with, for example, a traverse distance (“X”), an elevation (“Y”), and a straightforward distance (“Z”) as depicted in FIG. 1A. In some embodiments, either the X-axis or the Y-axis may coincide with a reference axis such as true north or magnetic north.

In some embodiments, the coordinate system may be a 2D coordinate system that includes the one or more coordinate axes defined by a width and a height of a pixel that digitally represents an image as within the image coordinate system. In some embodiments, the one or more coordinate axes may be defined by a width and a height of an image sensor (i.e., receiver) within the imaging device that may define an imaging plane such as within a sensor coordinate system. The imaging plane may be segmented along a grid pattern with rows and columns. Distances along the sensor coordinates may be measured using, for example, a metric system or an imperial system of measurement.

FIG. 1B depicts another example surface (100) from which the surface analysis system (101) acquires the collection data (125) in accordance with one or more embodiments. In some embodiments, the surface (100) may be a building (for example, building (30)), bridge, road, or other man-made structure. For simplicity and ease of reading, similar components already described in relation to the previous figure will not be repeated here. The building (30) may include a building edge (150) and/or a building face (155). The surface (100) may include the building edge (150) and/or the building face (155). The point markers (114) may be identified with corners of the building edge (150) and/or building face (155) or at various other locations along the building edge (150) and/or the building face (155). The imaging device(s) (115) may be positioned so as to be pointed in a direction toward the building edge (150) and/or the building face (155) such as to be normal to the building edge (150) and/or the building face (155). In some embodiments, the imaging device(s) (115) may be positioned to be oblique to the building edge and/or the building face (155).

FIG. 2A shows an example illustration showing a concept of simulated perspective-projection that may be used by the imaging device (115) to capture an image, such as image (211) as described in relation to FIG. 2B and FIGS. 3A-3B, of the surface (100). The image may be formed by the surface (100) reflecting and/or emitting light at reflection points (214) in 3D space and a portion of the reflecting and/or emitting light may travel toward the imaging device (115) as depicted by a plurality of image rays (202) in FIG. 2A. At least a portion of the reflected and/or emitted light is received by the imaging device (115). The image may be represented in an image plane (203) of the imaging device (115). The image plane (203) may be representative of a location of the receiver of the imaging device (115). A nodal point (204) or center of projection of the imaging device (115) may be representative of a center of projection of a received portion of the plurality of image rays (202). The imaging device (115) includes a focal length (205). The focal length (205) may be a distance between the nodal point (204) and the image plane (203).

In some embodiments, the imaging device (115) may be positioned using a device coordinate system (201) defined by the configuration of the lens and receiver. The device's origin may be defined as the nodal point (204) (i.e., the center point of perspective projection such as the nodal point (204) of an image sensor). The directional vectors (119) of the imaging device (115) may be representative of the positioning of the imaging device (115) in relation to the imaging device's receiver and lens configuration. For example, a “forward” vector may be defined by the direction where one of the image rays (202) may pass through the lens and perpendicularly impact the receiver. An “up” vector may be defined, for example, by the up direction relative to a ground surface (118) or a local geodetic surface or the up direction may be relative to the physical orientation of the imaging device (115). “Right” or “left” vectors may be defined by a right or left direction relative to the forward vector. One or more device coordinates may be determined based on the position and orientation of the imaging device (115). The one or more coordinate axes of the device coordinate system (201) may be segmented, for example, using the imperial or metric systems of measurement.

In some embodiments, the sensor coordinate system (240) may be determined based on the image plane (203) and one or more coordinate axes (241, 242). The image plane origin may be located in the center of the image plane (203). The image plane (203) may be determined based on the width and height of an image sensor. Sensor coordinates may be determined based on segmenting the width and height of the image plane (203) into equidistant segments. The image plane (203) may be centered with the principal axis (212) (e.g., principal point of symmetry) of the imaging device (115).

In some embodiments, the imaging device (115) may include an image sensor such as image sensor (206), such as a charge-coupled device (“CCD”) sensor, which may be physically behind a center of projection, e.g., the nodal point (204), of an imaging device. If an image sensor is physically behind the center of projection, the sensed image may be a “mirror” image of the surface (100) and surroundings within the imaging device's aperture. The image's pixel values may be represented at the image plane (203) located some distance in front of the nodal point (204) or center of projection in order to negate the mirror imaging of the surface (100). This distance may be equal to the focal length (205). The image sensor has a physical size (for example, 36 millimeters (mm) in width and 24 mm in height with 8256 by 5504 pixels resolution having a physical pixel size of approximately 4.36 micrometers and a focal length of 105 mm). The focal length (205) of the imaging device setup has an initially estimated value that may be subject to optimization by finding an actual or best-fit value of the focal length (205). The pixel values in the image may have been distortion-corrected, as known to those skilled in the art, so that rays passing from the nodal point (204) through the image plane (203) into the 3D-world can be represented as straight lines or rays intersecting both the appropriate object in the world which has reflected or emitted the light, and the corresponding pixel in the sensor or the image plane (203) which represents the sensing of that light.

FIG. 2B depicts a schematic diagram of the surface analysis system (101) in accordance with one or more embodiments. The surface analysis system (101) may be configured to plot one or more plot points (232) on an image (211) in real-time or after processing the image (211).

In some embodiments, the imaging device (115) is configured to capture the collection data (125) such as surface imaging data (210). The surface imaging data (210) may include an image (211) of the surface (100). The image (211) may be captured in a format suitable for being displayed on a 2D display using a coordinate system such as an image coordinate system (222). For example, the image (211) may be a 2D raster that includes a plurality of pixels. Each pixel includes a pixel value that, for example, may be obtained by sensing, using the imaging device (115), incoming light from a 3D space using a camera lens operating under a principle of perspective projection.

In some embodiments, the lens may distort the image (211) compared to real-world scenery and objects. For example, straight lines, such as building edges, in the real-world may appear as curved lines in the image (211). Lens distortion parameters may quantify the distortion of the image (211) by the lens. Lens distortion parameters may be used to determine a distortion of the image (211) in order to plot the one or more plot points (232) correctly on the image (211). The imaging device (115) may be configured to capture a lens distortion parameter (207).

In some embodiments, the feature analysis system (130) is configured to receive the collection data (125) from the imaging device (115) and the positioning device (120). The feature analysis system (130) may utilize one or more lens distortion parameters (207) of the imaging device (115) to correctly map each tie point (225) on the image (211). Lens distortion parameters (207) may be captured from the imaging device (115) and communicated with the feature analysis system (130). Lens distortion parameters (207) may be captured only once for each imaging device/lens combination for each location of the imaging device (115). In some embodiment, the lens distortion parameters (207) may be captured from known databases of lens distortion parameters.

In some embodiments, the feature analysis system (130) may be configured to display the image (211) using the image coordinate system (222). Each tie point (225) may include one or more pixel coordinates (223) within the image coordinate system (222). The image coordinate system (222) may be used to define a digital representation of a portion of the image (211) that includes a pixel grid arranged in rows and columns with each grid node including one of the pixels of the image (211).

In some embodiments, the image coordinate system (222) may be based on an image origin and a pixel grid. The pixel grid may be arranged in rows and columns of pixels. The pixel origin may be located on one of the pixels within the pixel grid, for example, in the center of the image or in a corner of the pixel grid.

The feature analysis system (130) may be configured to determine one or more tie points (225) and assigning the pixel coordinates (223) to each tie point (225) based on the location of each tie point (225) within the image coordinate system (222). The tie points (225) may be selected on the image (211). In some embodiments, the tie points (225) may be selected by a user. In some embodiments, the tie points (225) may be selected using one or more machine-learning algorithms (231) that may use training data based on a portion of the collection data (125) and/or a priori information. The tie points (225) may be selected so as to correspond to the surface (100) such as the geologic fault (106) or the building face (155). Based on the disclosure herein, it will be apparent to one skilled in the art to what constitutes a priori information such as, but not limited to, previously mapped geologic faults and/or buildings.

In some embodiments, location data (215) may include the straightforward distances (131), the traverse distances (132), the elevations (134), and the directional vectors (119) of various components of the surface analysis system (101), such as the imaging device (115), in relation to other components and the surface (100). The location data (215) may be used to determine the one or more location coordinates (220) (e.g., XYZ coordinates) of the various components of the surface analysis system (101) within the world coordinate system (190). For each tie point (225), one of the point markers (114) may be identified on the surface (100).

In some embodiments, the feature analysis system (130) may be configured to transform the tie points (225) within the image coordinate system to expected tie points within the sensor coordinate system (240). Each tie point (225) is positioned on the image plane (203) and located using transformation of the pixel coordinates (223) of the image coordinate system (222) to sensor coordinates (224) of the sensor coordinate system (240). To transform between the pixel coordinates (223) and sensor coordinates (224), the feature analysis system (130) may be configured to apply a scale factor. For example, to transform between the pixel coordinates (223) (Xₚ, Yₚ) and the sensor coordinates (224) (Xᵢ, Yᵢ) (e.g., expected sensor coordinates), the following conversion may be used as follows:

$${Y}_{i} = {Y}_{p} * ( height of sensor / height of image ) , \qquad ( 1 )$$

$${X}_{i} = {X}_{i} * ( width of sensor / width of image ) . \qquad ( 2 )$$

In some embodiments, the feature analysis system (130) may be configured to orientate the image (211) with respect to the world coordinate system (190). Each point marker (114) may be correlated to one of the tie points (225). In order to position and orientate the image (211), the location of each point marker (114) located on the surface (100), is measured (for example, the location data (215) measured by the positioning device (120) and the resulting location data is used to determine each location coordinate (220)).

In some embodiments, the feature analysis system (130) may be configured to transform between the location coordinates (220) and the imaging coordinates using a plurality of transformation parameters (226). A reference point on the surface (100) or location of the imaging device (115) may be defined, for example, with the location coordinates (220) (Xₙ, Yₙ, Zₙ). The imaging device's forward vector may be represented, for example, as (X_{f}, Y_{f}, Z_{f}) and the up vector as (Xᵤ, Yᵤ, Zᵤ).

In some embodiments, the feature analysis system (130) may be configured to calculate the plurality of transformation parameters (226). The plurality of transformation parameters (226) may be determined using linear algebra and the following equations defining one or more translation and rotational operations. In some embodiments, the feature analysis system (130) may be configured to determine a transformation matrix. The plurality of transformation parameters (226) may be used to construct the transformation matrix. Based on the disclosure herein, a person of ordinary skill in the art will understand how to formulate the transformation matrix from the following translation and rotational operations.

In some embodiments, the nodal point (204) of the imaging device (115) may include translating, using one or more translation parameters, the coordinate of the nodal point (204) to a reference point located in the world coordinate system (190). The translation parameters may be determined by subtracting each location coordinate dimension of the nodal point (204) from the corresponding location coordinate dimension of the reference point. The plurality of transformation parameters (226) may include a first translation parameter, a second translation parameter, and a third translation parameter with each parameter corresponding to a dimension of the first coordinate system. For example, using an XYZ coordinate, the first, second, and third translation parameters may be determined as follows:

$$point {x}^{′} = {X}_{n} - {X}_{translation} , \qquad ( 3 )$$

$$point {y}^{′} = {Y}_{n} - {T}_{translation} , \qquad ( 4 )$$

$$point {z}^{′} = {Z}_{n} - {Z}_{translation} , \qquad ( 5 )$$

where Xₜᵣₐₙₛₗₐₜᵢₒₙ, Yₜᵣₐₙₛₗₐₜᵢₒₙ, and Zₜᵣₐₙₛₗₐₜᵢₒₙ is the distance to translate each coordinate to align the origins of each coordinate system, such as the world coordinate system (190) and the device coordinate system (201), within a 3D space.

In some embodiments, the directional vectors (119) of the camera (e.g., the forward vector and the up vector) within the device coordinate system (201) may be rotated to align with the coordinate system axes, for example, the forward vector aligned with the Z-axis in its negative direction. An inner angle, θ_{f_Z}, between the forward vector and the negative Z-axis, may be calculated between the directional vectors (119) and the coordinate system axes as follows:

$${θ}_{f \_ Z} = a cos ( - {Z}_{f} / ( {X}_{f}^{2} + {Y}_{f}^{2} + {Z}_{f}^{2} ) , \qquad ( 6 )$$

where acos is the arccosine. To apply the rotation such that the forward vector is aligned with the negative Z-axis, first, using axes-aligned operations, rotate around the Z-axis so that the forward vector is aligned, with respect to its projection into the XY-plane, with one of the X-axis or Y-axis. For example, to align with respect to the positive Y-axis, determine the angle, θ_{PreRot_Z}, between the positive Y-axis and the forward vector projected on to the XY-plane for rotation around the Z-axis as follows:

$${θ}_{PreRot \_ Z} = a tan 2 ( - {X}_{f} , {Y}_{f} ) , \qquad ( 7 )$$

where the first parameter is the sine component of the angle, the second parameter is the cosine of the angle, and where atan 2 calculates an angle that is from 0 to 2pi.

In some embodiments, the plurality of transformation parameters (226) may include a first rotation parameter. The first rotation parameter may be determined from the first rotational operation which is defined as follows:

$${point\_x}^{″} = {point\_x}^{′} * cos ( - {θ}_{PreRot \_ Z} ) - {point\_y}^{′} * sin ( - {θ}_{PreRot \_ Z} ) , \qquad ( 8 )$$

$${point\_y}^{″} = {point\_x}^{′} * sin ( - {θ}_{PreRot \_ Z} ) + {point\_y}^{′} * cos ( - {θ}_{PreRot \_ Z} ) , \qquad ( 9 )$$

$${point\_z}^{″} = {point\_z}^{′} , \qquad ( 10 )$$

where the first rotation operation may be used to rotate about Z-axis such that the camera's forward vector has a projection in the XY-plane that is aligned with the Y-axis.

In some embodiments, the plurality of transformation parameters (226) may include a second rotation parameter. The second rotation parameter may be determined from the second rotational operation which is defined as follows:

$$sin Value = sin ( - {θ}_{f \_ z} ) , \qquad ( 11 )$$

$$cos Value = cos ( - {θ}_{f \_ z} ) , \qquad ( 12 )$$

$${point\_x}^{′′′} = {point\_x}^{″} , \qquad ( 13 )$$

$${point\_y}^{′′′} = {point\_y}^{″} * cos Value - {point\_z}^{″} * sin Value , \qquad ( 14 )$$

$${point\_z}^{′′′} = {point\_y}^{″} * sin Value - {point\_z}^{″} * cos Value , \qquad ( 15 )$$

where the second rotation operation may be used to rotate about the X-axis such that the forward vector of the imaging device (115) will align with the negative Z-axis.

To determine the up vector of the imaging device (115) is in its standard position of looking towards the positive-y axis, to align with respect to the positive Y-axis, determine the angle, θ_{PostRot_Z}, between the positive Y-axis and the up vector as follows:

$${θ}_{PostRot \_ Z} = a tan 2 ( - {up}_{{x}^{″}} , {up}_{{y}^{″}} ) , \qquad ( 16 )$$

where the −up_{x″}, and up_{y″} the up vector of the imaging device (115) after applying the first two rotations.

In some embodiments, the plurality of transformation parameters (226) may include a third rotation parameter. The second rotation parameter may be determined from the third rotational operation which is defined as follows:

$${point\_x}^{′′′′} = {point\_x}^{′′′} * cos ( - {θ}_{PostRot \_ Z} ) = {point\_y}^{′′′} * sin ( - {θ}_{PostRot \_ Z} ) , \qquad ( 17 )$$

$${point\_y}^{′′′′} = {point\_x}^{′′′} * sin ( - {θ}_{PostRot \_ Z} ) + {point\_y}^{′′′} * cos ( - {θ}_{PostRot \_ Z} ) , \qquad ( 18 )$$

$${point\_z}^{′′′′} = {point\_z}^{′′′} . \qquad ( 19 )$$

where the third rotation operation rotates the up vector to be directed toward the positive y-axis of the world coordinate system (190).

In some embodiments, the feature analysis system (130) may be configured to transform device coordinates (221) within the device coordinate system (201) to projected sensor coordinates (e.g., sensor coordinates as defined by the translation and rotational operations above) by projecting the transformed coordinates, such as (X″″, Y″″, Z″″), to the image plane (203) as follows:

$${X}_{i} = {point\_x}^{′′′′} * {l}_{f} / ( - {point\_z}^{′′′′} ) , \qquad ( 20 )$$

$${Y}_{i} = {point\_y}^{′′′′} * {l}_{f} / ( - {point\_z}^{′′′′} ) , \qquad ( 21 )$$

where if is the focal length (205), Xᵢ is the x-axis projected sensor coordinate within the image plane (203), and Yᵢ is the y-axis projected sensor coordinate within the image plane (203).

In some embodiments, the feature analysis system (130) may be configured to identify an additional point marker, such as the additional point marker (121), located on the surface (100). In some embodiments, the feature analysis system (130) may be configured to identify the additional point marker (121) by user input. In some embodiments, the feature analysis system (130) may be configured to identify an additional point marker, such as the additional point marker (121), automatically using the machine-learning algorithm (231). In some embodiments, the feature analysis system (130) may be configured to plot the plot point (232) on the image (211) automatically transformed from the additional point marker (121) in real-time. In some embodiments, the feature analysis system (130) may be configured to plot the plot point (232) on the image (211) automatically transformed from the additional point marker (121) after processing of the image (211) has been completed. In some embodiments, the feature analysis system (130) may be configured to plot the one or more plot points (232) at a position on the image (211) in the 2D display. The one or more plot points (232) may be located on the image (211) of the surface (100) such as a geologic fault or face of a building.

In some embodiments, the feature analysis system (130) may be configured to calculate an error (229) between the pixel coordinates (223) transformed to the sensor coordinate (224) within the image plane (203), and the point markers (114) transformed to sensor coordinates. The feature analysis system (130) may be configured to use a least-squares method and gradient descent optimization techniques to minimize the error (229) in the process of solving for the transformation parameters (226). The transformation parameters (226) may be used to transform between the sensor coordinates (224) and the location coordinates (220). To transform between the location coordinates (220) and the sensor coordinates (224), an initial guess or running estimate of the transformation parameters may be used. In some embodiments, the error (229), E, (also known as an objective function error and/or residuals) may be calculated as follows:

$$E = {\sum }_{1}^{N} {( {X}_{i \_ expected} - {X}_{i \_ projected} )}^{2} + {( {Y}_{{i}_{expected}} - {Y}_{i \_ projected} )}^{2} , \qquad ( 22 )$$

where N is for the number points (for example, N>=4). The X_{i_expected} and Y_{i_expected} values represent each expected (X,Y) coordinate from each tie point (225) identified in the image (211) located by the pixel coordinates (223) transformed to the sensor coordinates (224). The X_{i_projected} and X_{i_projected} values represent the location coordinates (220) of the point markers (114) transformed to the sensor coordinates (224) after transforming from the location coordinates (220) to imaging coordinates. The objective function error expressed in Eq. (22) may be minimized using, for example, a least-squares solution (228) that may include a gradient-descent numerical optimization.

In some embodiments, the feature analysis system (130) may be configured to incorporate an adjustment (233). For example, the adjustment (233) may be part of the image distortion correction process so that the image (211) is centered with the principal axis (212) (e.g., principal point of symmetry) of the imaging device (115). The adjustment (233) may include an offset adjustment configured to correct for principal point offset.

In some embodiments, the feature analysis system (130) may be configured to calculate a feature (230) of the surface (100) based on the tie points (225) and the plot point (232). The feature analysis system (130) may be configured to apply mathematical calculations, as known to those skilled in the art, to calculate the feature (230), such as the strike, dip, trend, plunge, bedding thicknesses, etc. Each additional point marker (121) will be plotted on the image (211) as plot points (232) transformed from the additional point markers (121). The image (211) may be displayed in the 2D display. In some embodiments, the one or more additional point markers (121) may also be plotted on a 3D display such as 3D display (300). The 3D plot of the point markers (114) may be used to calculate features, such as the feature (230), while the tie points (225) may be plotted on the image (211) or within the 2D display.

In some embodiments, the feature analysis system (130) may be configured to verify in real-time that the surface measurements (e.g., the location data (215) of the point markers (114)) are accurate and as intended. The feature analysis system (130) may be configured to verify the location data (215) by plotting the location data (215) into a 2D display and compare to a 3D display for quality assurance purposes. In some embodiments, the feature analysis system (130) may be configured to automatically identify features from the image (211) through image processing and then automatically trigger the positioning device (120) to make corresponding location data measurements (e.g., 3D surface measurements) accordingly.

The feature analysis system (130) may include a computer system similar or the same to the computer system (500) as described in relation to FIG. 5 and accompanying description. However, the feature analysis system (130) may be configured with appropriate feature analysis software and augmented with a number of purpose specific elements, such as high-speed buses connecting computer units (“CPUs”). Further the CPUs of a feature analysis system may be connected to a plurality of graphical processing units (“GPUs”) that perform many of the computationally intensive operations on the surface imaging data (210). The feature analysis software may include image processing capabilities for processing the surface imaging data (210), such as, but not limited to, filtering, noise reduction, image segmentation, and edge detection.

Peripherals like keyboards, mice, and graphics tablets enable efficient interaction with data and software interfaces. In some cases, users may need remote access to the feature analysis system (130). Setting up remote access capabilities, such as Virtual Private Networks (VPNs) or remote desktop solutions, allows interpreters to work from different locations and share their work effectively. The feature analysis system (130) may be customized to meet the needs of users and the specific requirements of projects. The hardware specifications may vary based on factors like the complexity of interpretations, the size of data sets, and the software tools utilized.

In accordance with one or more embodiments, the feature analysis system (130), a well planning system, and a construction planning system may include hardware and/or software with functionality for generating and/or updating one or more machine-learning models using the one or more machine-learning algorithms (231) to determine the tie points (225) and/or calculate the feature (230), designing a construction plan, and/or designing a well development plan. Examples of machine-learning algorithms (231) may include random forest algorithms and artificial neural networks, such as convolutional neural networks, deep neural networks, and recurrent neural networks. Machine-learning algorithms (231) may also include, but not limited to, support vector machines, decision trees, inductive learning models, deductive learning models, supervised learning models, unsupervised learning models, reinforcement learning models, etc. The hardware and/or software may be configured to perform operations disclosed herein automatically, for example, calculating the feature (230) automatically.

In some embodiments, determining the tie points (225), calculating the feature (230) and any intermediate products, a construction plan and/or a well drilling plan may include using artificial neural networks such as deep neural networks. In a deep neural network, for example, a layer of neurons may be trained on a predetermined list of features based on the previous network layer's output. Thus, as data progresses through the deep neural network, more complex features may be identified within the data by neurons in later layers. Likewise, a U-net model or other type of convolutional neural network model may include various convolutional layers, pooling layers, fully connected layers, and/or normalization layers to produce a particular type of output. Thus, convolution and pooling functions may be the activation functions within a convolutional neural network. In some embodiments, two or more different types of machine-learning models are integrated into a single machine-learning architecture, e.g., a machine-learning model may include K-nearest neighbor (k-NN) models and neural networks. In some embodiments, the feature analysis system (130) and/or the well planning system, and the construction planning system may generate augmented data or synthetic data to produce a large amount of interpreted data for training a particular model.

In some embodiments, various types of machine-learning algorithms may be used to train the machine-learning models, such as a backpropagation algorithm. In a backpropagation algorithm, gradients are computed for each hidden layer of a neural network in reverse from the layer closest to the output layer proceeding to the layer closest to the input layer. As such, a gradient may be calculated using the transpose of the weights of a respective hidden layer based on the objective function (also called a “loss function”). The objective function error may be based on various criteria, such as mean squared error function, a similarity function, etc., where the objective function error may be used as a feedback mechanism for tuning weights in the machine-learning models.

In some embodiments, machine-learning models may be trained using multiple epochs. For example, an epoch may be an iteration of a model through a portion or all of a training data set. As such, a single machine-learning epoch may correspond to a specific batch of training data, where the training data is divided into multiple batches for multiple epochs. Thus, machine-learning models may be trained iteratively using epochs until the model achieves a predetermined criterion, such as predetermined level of prediction accuracy or training over a specific number of machine-learning epochs or iterations. Thus, better training of a model may lead to better predictions by a trained model.

It will be appreciated by a person having ordinary skill in the art that the collection data (125) are extremely large, typically occupying hundreds of Gigabytes to Terabytes of data samples and cannot be manipulated or “processed” without the assistance of the feature analysis system (130) purposely configured to handle the collection data (125). Based upon the disclosure provided herein, one of ordinary skill in the art will appreciate that the gathering of the data involves specialized tools to obtain the vast quantities of gathered data, and high-speed processing capability capable of performing at least one thousand calculations per second. Indeed, in some embodiments, processors capable of millions, billions, or even more calculations per second are used.

In some embodiments, the surface analysis system (101) may include a geospatial database (245). The feature analysis system (130) may be configured to label, document, and store information, attributes, and characteristics about the feature (230) within the geospatial database (245).

In some embodiments, the surface analysis system (101) may include a feature interpretation workstation (250) configured to analyze and visualize the feature (230). The feature interpretation workstation (250) may include a computer system similar to or the same as the computer system (500) as described in relation to FIG. 5. The feature interpretation workstation (250) may be configured with specialized feature interpretation software. The feature interpretation workstation (250) may be augmented with a number of purpose specific elements, such as high-capacity tape drives or hard drives connected through high-speed buses to computer processing units (“CPUs”). Further the CPUs of a feature processing system will typically be connected to a plurality of graphical processing units (“GPUs”) that perform many of the computationally intensive operations on surface and feature data, banks of high-speed tape, or hard-drive, readers to read the data from storage, high-speed tape, or hard-drive writers to output final or intermediate results, and high-speed communication buses to connect these elements.

The feature interpretation workstation (250) is primarily used by geoscientists and/or civil engineers for analyzing surface and feature data gathered and calculated by the surface analysis system (101) to understand geologic and/or man-made structures. Geologic interpreters and/or civil engineers use the feature interpretation workstation (250) to visualize surfaces and features, including 2D and 3D visualization, including one or more cross-sections (234) and attribute maps. These visualizations provide insights into structures, surfaces such as faults and/or faces of man-made structures. Additional data may be used within the feature interpretation workstation (250) to facilitate the interpretation of the surface and feature data. Such additional data may include well logs acquired from previously drilled wells and acquired either while-drilling or via wireline conveyed logging tools after drilling. Such data may also include remote sensing data sets such as seismic, resistivity, transient electromagnetic, and/or gravitational surveys but are not limited to this. Additional data may also include geotechnical data such as soil compaction information, soil saturation, soil stability data, and the like.

Interpreters may pick and interpret key geological horizons within the remote sensing data set to identify stratigraphic layers, boundaries, and structural features. Horizon interpretation tools and workflows allow for the accurate extraction of geological information from subsurface volumes. For example, a feature interpretation workstation (250) enables interpreters to identify and interpret subsurface faults that may coincide with the feature (230). Fault interpretation tools and visualization techniques help in understanding fault geometry, connectivity, and spatial relationships. Subsurface attributes, such as amplitude, frequency, and gradient, provide additional information about subsurface properties and can be analyzed using various algorithms and statistical methods. Attribute analysis tools in the workstation aid in defining reservoir characteristics, identifying anomalies, and highlighting potential hydrocarbon traps.

In accordance with one or more embodiments, geologic interpreters may use the feature interpretation workstation (250) to build the one or more geologic models by integrating surface and feature data with well-log data, geological knowledge, and other geophysical information. The one or more geologic models help in estimating reservoir properties, optimizing well locations, and predicting hydrocarbon distribution. Interpreters may analyze and characterize the formation by integrating different data sources, including the surface and feature data, well logs, production data, and subsurface inversion results. The feature interpretation workstations (250) may provide tools for coloring and/or filling an area of the surface, rock volume estimation, reservoir property estimation, quantitative analysis, and reservoir performance evaluation.

In accordance with one or more embodiments, civil engineers may use the feature interpretation workstation (250) to build the one or more structural stability models by integrating surface and feature data with soil compaction, engineering knowledge, and other geotechnical information. The one or more structural stability models help in estimating structural properties, optimizing remediation operations, and predicting structural stability such as if the structure is leaning. Interpreters may analyze and characterize the structure by integrating different data sources, including the surface and feature data, soil studies, and subsurface analysis results.

FIG. 3A depicts an idealized example image captured of an example outcrop using the surface analysis system (101) in accordance with one or more embodiments. The pixel coordinates (223) of the tie points (225) may be used to plot each tie point (225) on the image (211). The pixel coordinates (223) may be based on an image origin (310) and one or more image distances (e.g., an image horizontal distance (330) and an image vertical distance (332)). The image (211) may include a plurality of pixels that may be arranged in a pixel grid with rows and columns. The one or more image distances may be based on the pixel width and height and the number of pixels along the coordinate axes (311) of the image coordinate system (222).

In some embodiments, the additional point marker (121) may be plotted on the image (211), after conversion to projected sensor coordinates and then pixel coordinates, in a 2D display (320) and simultaneously the additional point marker (121) may be plotted in the 3D display (300) using, for example, device coordinates (221) transformed from location coordinates (220). In some embodiments, the 3D plotted points may be used to calculate the feature (230). In some embodiments, the tie points (225) may be plotted in the 2D display (320). For example, four tie points are selected on the image (211). Locations of the one or more point markers (114) on the surface (100), which relates to each tie point (225) on the image (211), is measured with the positioning device (120). Based on the disclosure herein, it will be apparent to those skilled in the art that any number of tie points may be used to formulate the plurality of transformation parameters (226).

After the four tie points are captured and the location data (215) of the subsequent point markers are measured and calibrated to within the world coordinate system (190), the plurality of transformation parameters (226) that relate the surface (100) to the image (211) are calculated and described above. All additional point markers, such as the additional point marker (121), that are calibrated using the positioning device (120) are plotted on the image (211). The feature analysis system (130) may be configured to determine an accuracy parameter (328) by comparing the error (229) between expected sensor coordinates of each expected tie point (324) and projected sensor coordinates of each projected point marker (325) after applying a transformation (350) using the transformation parameters (226). If the error (229) is greater than an accuracy threshold (329), then one or more steps of transformation (350), as determined by Eq. (1)-(22), may be re-initiated with perturbations to inputs such as the lens distortion parameter (207) such that the error (229) may be decreased. The accuracy threshold (329) may be, for example, two pixels in displacement of the expected and projected sensor coordinates.

In some embodiments, the feature analysis system (130) may be configured to generate the cross-section (234) such as being configured to determine one or more “best-fit” planes (355) to a set of corresponding location data points. A best-fit algorithm, such as a least-squares method, may be used to determine the best-fit plane (355) from the tie points (225), the expected tie points (324), the projected point markers (325), the plot points (232) or combination thereof. Based on the disclosure herein, it will be apparent to those skilled in the art the various methods that may be used to determine a best-fit plane.

The resulting points can be displayed in the 3D display (300) for visualization of the surface (100). The tie points (225), expected tie points (324), projected point markers (325), and/or plot points (232) can be converted into polylines and/or polygons that may be visualized in 2D and/or 3D displays. The polylines and/or polygons may be filled with a color and/or a pattern fill. The feature analysis system (130) may be configured to fill the polylines and/or polygons with a color and/or a pattern fill. For geological outcrops, for example, the integrated tools (or point-based tools in various software such as geologic visualization and analysis system) can be used to analyze the orientations of the features which have been plotted. In some embodiments, the expected tie points (324) may be transformed into device coordinates using the transformation (350).

All additional point markers, such as the additional point marker (121) which are captured, may be plotted on the image (211) in real-time and/or after image processing using the transformation (350). The feature analysis system (130) may be configured to label and document all points (e.g., tie points (225), expected tie points (324), projected point markers (325) and/or plot points (232)) in the geospatial database (245). The geospatial database (245) may be, for example, a geographic information system (GIS) such as ArcGIS.

FIG. 3B shows a more realistic example image captured of an example outcrop using the surface analysis system (101) in accordance with one or more embodiments. FIG. 3B depicts the image (211) showing an outcrop having one or more geologic layers (110A, 110B, 110C) separated by one or more geologic surfaces (111A, 111B). The outcrop is segmented by a geologic fault (106). The best-fit plane (355) is modeled from feature points (361) selected from the tie points (225), the expected tie points (324), the projected point markers (325), the plot points (232), or combination thereof along the geologic surface (110A) interpreted as a horizon (360).

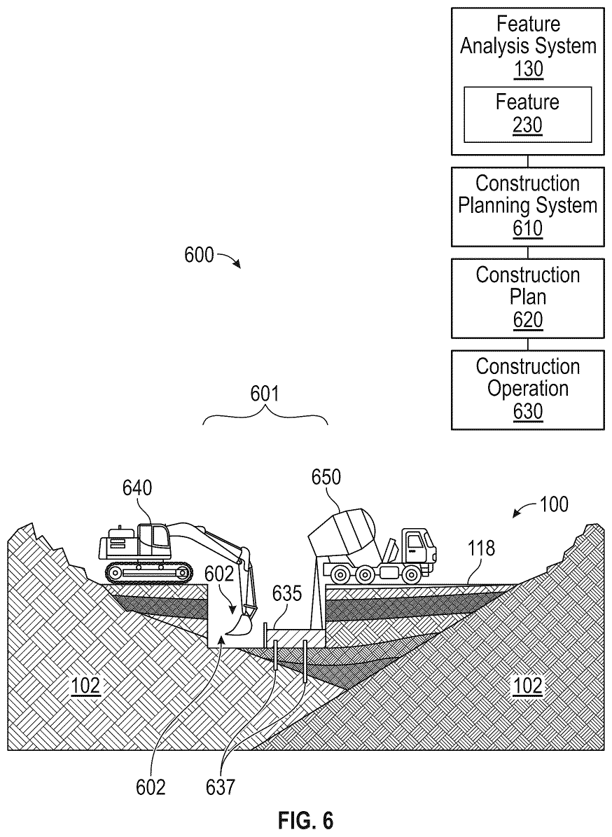

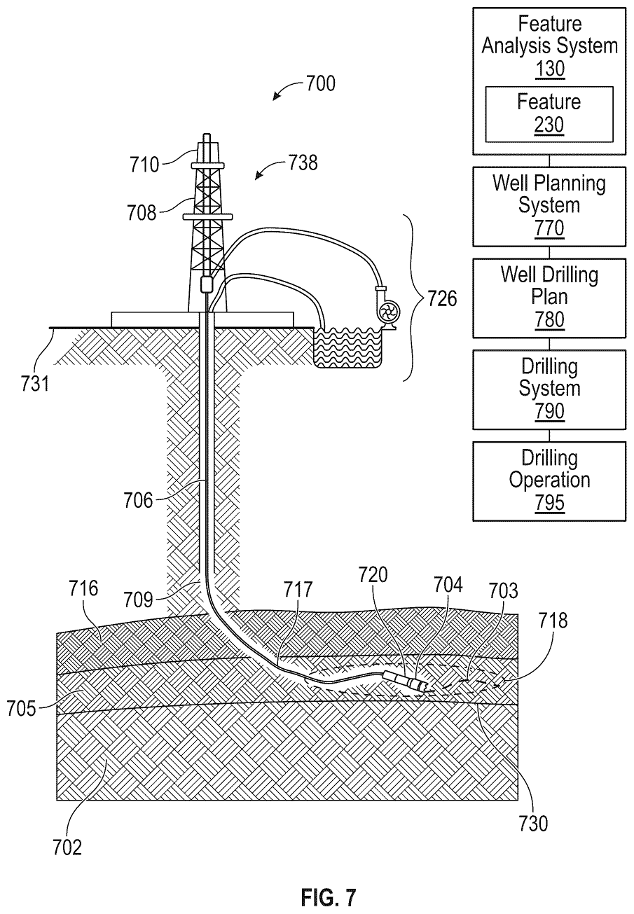

Additional plot points and/or point markers may be selected and mapped onto the image (211) in the 2D display and/or a 3D model in the 3D display to model additional best-fit planes similar to the best-fit plane (355). This may be done in real-time to expedite decision-making for real world applications such as real-world examples discussed below in relation to FIG. 6 and FIG. 7. Additional features, for example, each segment of the geologic surfaces (111A, 111B) spanning across the geologic fault (106), and the geologic fault (106) itself may be mapped with additional point markers and plot points. Each feature may then be modeled by a best-fit plane and corresponding group of data points.

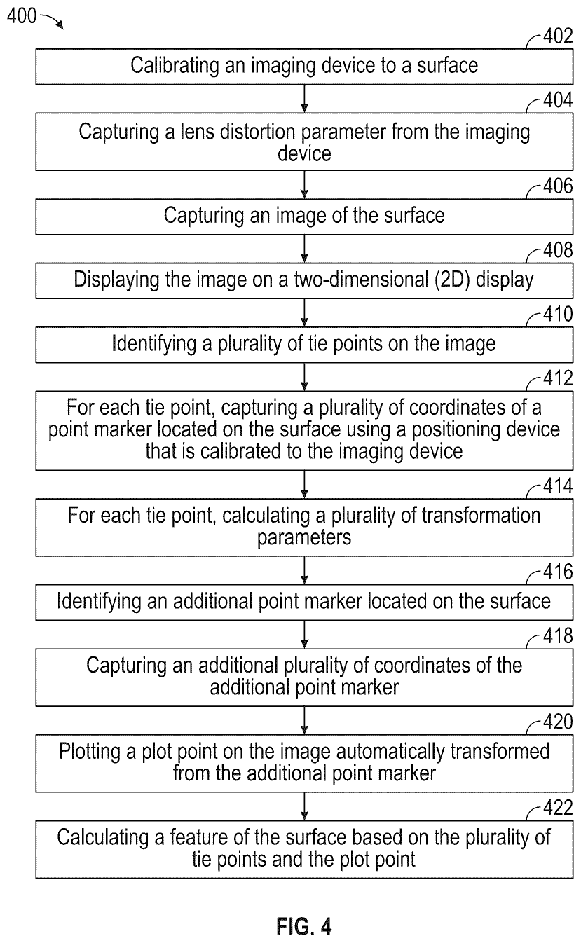

FIG. 4 depicts a flowchart in accordance with one or more embodiments describing a method for determining a characteristic of a surface (hereafter “determination method” (400)). In some embodiments, the determination method (400) may use the surface analysis system (101) in carrying out one or more steps. Although the flowchart using the determination method (400) is shown in sequential order, it will be apparent to one of ordinary skill in the art that some steps may be conducted in parallel, in a different order than shown, or may be omitted without departing from the scope of the invention.

In Block (402), the determination method (400) includes calibrating the imaging device (115) to the surface (100) in accordance with one or more embodiments. The surface analysis system (101) is positioned at a location where the features, such as feature (230) are to be measured. In some embodiments, calibrating the imaging device (115) to the surface (100) may include measuring the location data (215) between the imaging device (115) and the surface (100). In some embodiments, calibrating the imaging device (115) may include measuring the one or more directional vectors (119) in relation to a reference axis.

In Block (404), the determination method (400) includes capturing the lens distortion parameter (207) from the imaging device (115) in accordance with one or more embodiments. The lens distortion may be representative of the amount of distortion that the lens imposes on the image (211). Each camera/lens combination must have a separate set of distortion parameters.

In Block (406), the determination method (400) includes capturing, using the imaging device (115), the image (211) of the surface (100) in accordance with one or more embodiments. The image (211) may be communicated with the feature analysis system (130). In some embodiments, the determination method (400) may include processing the image (211) using processes such as filtering, noise reduction, image segmentation, and edge detection.

In Block (408), the determination method (400) includes displaying the image (211) on a display in accordance with one or more embodiments. The display may include a 2D display. The image (211) may be displayed on the display using a coordinate system such as the sensor coordinate system (240).

In Block (410), the determination method (400) includes identifying the tie points (225) on the image (211) in accordance with one or more embodiments. Each tie point (225) may be representative of a point marker on the surface (100). The position of each point marker (114) is measured using the positioning device (120). Multiple tie points (225) may be selected, and the point markers (114) may be mapped on the image (211) where each point marker (114) is correlated to each tie point (225).

In Block (412), the determination method (400) includes, for each tie point (225), capturing the one or more location coordinates (220) of the point marker (114) located on the surface (100) using the positioning device (120) that is calibrated to the imaging device (115) in accordance with one or more embodiments.

In Block (414), the determination method (400) includes calculating the plurality of transformation parameters (226) in accordance with one or more embodiments. In some embodiments, one or more of the other steps may be repeated if errors, such as the error (229), of the calculation of the transformation parameters (226) are greater than the accuracy threshold (329). In some embodiments, calculating the plurality of transformation parameters (226) may include calculating the plurality of transformation parameters (226) to transform 3D coordinates (e.g., location coordinates and/or device coordinates) of the surface (100) to 2D coordinates (e.g., pixel coordinates and/or sensor coordinates) of the image (211).

In some embodiments, the determination method (400) may include verifying in real-time that the surface measurements (e.g., the location data (215) of the point markers (114)) are accurate and as intended. In some embodiments, the determination method (400) may include verifying the location data (215) by plotting the location data (215) into a 2D display and comparing it to a 3D display for quality assurance purposes. In some embodiments, the determination method (400) may include automatically identifying features from the image (211) through image processing and then automatically triggering the positioning device (120) to make corresponding location data measurements (e.g., 3D surface measurements) accordingly.

In some embodiments, calculating the plurality of transformation parameters (226) may include calculating, using the least-squares method as know by those skilled in the art, the least-squares solution (228) yielding the transformation parameters (226). In some embodiments, the plurality of transformation parameters (226) may include a first rotation parameter, a second rotation parameter, a third rotation parameter, a first translation parameter, a second translation parameter, and a third translation parameter. In some embodiments, the transformation parameters are used to construct the transformation matrix.

In Block (416), the determination method (400) includes identifying the additional point marker (121) located on the surface (100) in accordance with one or more embodiments. Identifying the additional point marker (121) may include identifying the additional point marker (121) along the surface (100) automatically using the one or more machine-learning algorithms (231).

In Block (418), the determination method (400) includes capturing an additional plurality of location coordinates of the additional point marker in accordance with one or more embodiments. The additional plurality of location coordinates may be captured using the positioning device (120).

In Block (420), the determination method (400) includes plotting the plot point (232) on the image (211) automatically transformed from the additional point marker using the transformation parameters (226) in accordance with one or more embodiments. In some embodiments, the plot point (232) may be identified on the image of the surface and transformed to one or the plurality of point markers using the plurality of transformation parameters (226). In some embodiments, the plot point (232) may be identified automatically using the one or more machine-learning algorithms (231).

In Block (422), the determination method (400) includes calculating the feature (230) of the surface (100) based on the tie points (225) and the plot point (232) in accordance with one or more embodiments. In some embodiments, calculating the feature (230) may include calculating a strike, dip, trend, and/or plunge of the surface (100). The surface (100) may include, but not limited to, structural geologic surfaces and/or man-made structures, remotely in the field after post processing and/or real-time calculation. In some embodiments, calculating the feature (230) may include calculating bedding and/or layers properties, including but not limited to geological features and/or man-made structures, including thicknesses remotely in the field after post processing and/or real-time calculation. In some embodiments, the determination method (400) may include calculating a size of the surface (100) from the image (211) using the point data (e.g., the tie points (225), the expected tie point (324) the plot points (232), and/or the projected point markers (325)). In some embodiments, the size of the surface (100) may include, but not limited to, an area, a thickness, and/or a volume of the surface (100). In some embodiments, calculating the size of feature (230) may include calculating any specific geological area or volume remotely in the field in real-time. In some embodiments, calculating the feature of the surface may include calculating a location or position, such as a relative elevation (i.e., an elevation relative to the imaging device or some other reference point), of the feature.

In some embodiments, the determination method (400) may include documenting the feature (230) of the surface (100) in the geospatial database (245). In some embodiments, documenting the feature (230) may include documenting the feature (230) from geological surfaces to a corresponding image, such as the image (211), in real-time for documentation and validation of features. In some embodiments, the determination method (400) may include labeling any geological surface virtually with geological labels remotely in the field in real-time.

In some embodiments, the determination method (400) may include coloring an area within the image (211) corresponding to the feature (230) of the surface (100), wherein the surface (100) includes a geologic layer. Coloring and area may include coloring geological surfaces virtually representing bedding/layer properties. Coloring may be done remotely in the field in real-time based on the 3D plotted collection data (125) or regions identified in the image (211). Coloring an area within the image (211) may include tracing geological bedding/layer virtually (such as geological surfaces) remotely in the field in real-time. Coloring an area within the image (211) may include converting the point data (e.g., the tie points (225), the expected tie point (324) the plot points (232), and/or the projected point markers (325)) to polyline and/or polygons and filling in the polylines and/or polygons with a color and/or a pattern fill.

In some embodiments, the determination method (400) may include generating the cross-section (234) of the surface (100) automatically based on the feature (230) of the surface (100). Generating the cross-section (234) may include creating feature projections for geological surfaces, such as creating true down-plunge cross-sections remotely in the field in post processing and real-time. For example, generating the cross-section (234) may include determining one or more “best-fit” planes to a set of corresponding location data points. For example, two sets of location data points acquired from opposing limbs of the same geologic fold of a geologic bedding form two best-fit planes. The intersection of the two best-fit planes form a line that may represent the central axis of the fold. A “horizon” may be interpreted, using an interpretation workstation, from remote sensing data such as seismic data representing a bedding surface distorted by the fold. The horizon and the best-fit planes may be plotted in a 3D display. The central axis and horizons may be projected onto a pre-determined 2D plane to generate the cross-section (234) using the feature interpretation workstation (250).

In some embodiments, the determination method (400) may include designing, using a construction planning system, a construction plan of a structure based on the feature (230) of the surface (100). In some embodiments, the structure may be a foundation such as the foundation in relation to FIG. 6. In some embodiments, designing a foundation plan includes a plan for reinforcing the foundation, for example, using tie rods to couple the foundation (635) to the basement rock (102).

In some embodiments, the determination method (400) may include building, using a construction system, the foundation based on the structural plan. In some embodiments, the structure may be a foundation such as the foundation in relation to FIG. 6. In some embodiments, designing a foundation plan includes a plan for reinforcing the foundation, for example, using tie rods to couple the foundation (635) to the basement rock (102).

FIG. 5 further depicts a block diagram of a computer system (500) having a computer (502) that may be used to provide computational functionalities associated with described algorithms, methods, functions, processes, flows, and procedures as described in this disclosure, according to one or more embodiments. The illustrated computer (502) is intended to encompass any computing device such as a server, desktop computer, laptop/notebook computer, wireless data port, smart phone, personal data assistant (PDA), tablet computing device, one or more processors within these devices, or any other suitable processing device, including both physical or virtual instances (or both) of the computing device. Additionally, the computer (502) may include a computer that includes an input device, such as a keypad, keyboard, touch screen, or other device that can accept user information, and an output device that conveys information associated with the operation of the computer (502), including digital data, visual, or audio information (or a combination of information), or a GUI.

The computer (502) can serve in a role as a client, network component, a server, a database or other persistency, or any other component (or a combination of roles) of a computer system for performing the subject matter described in the instant disclosure. The illustrated computer (502) is communicably coupled with a network (516). In some implementations, one or more components of the computer (502) may be configured to operate within environments, including cloud-computing-based, local, global, or other environment (or a combination of environments).

At a high level, the computer (502) is an electronic computing device operable to receive, transmit, process, store, or manage data and information associated with the described subject matter. According to some implementations, the computer (502) may also include or be communicably coupled with an application server, e-mail server, web server, caching server, streaming data server, business intelligence (BI) server, or other server (or a combination of servers).

The computer (502) can receive requests over network (516) from a client application (for example, executing on another computer (502)) and responding to the received requests by processing the said requests in an appropriate software application. In addition, requests may also be sent to the computer (502) from internal users (for example, from a command console or by other appropriate access method), external or third-parties, other automated applications, as well as any other appropriate entities, individuals, systems, or computers.

Each of the components of the computer (502) can communicate using a system bus (504). In some implementations, any or all of the components of the computer (502), both hardware or software (or a combination of hardware and software), may interface with each other or the interface (506) (or a combination of both) over the system bus (504) using an application programming interface (API) (512) or a service layer (514) (or a combination of the API (512) and service layer (514). The API (512) may include specifications for routines, data structures, and object classes. The API (512) may be either computer-language independent or dependent and refer to a complete interface, a single function, or even a set of APIs. The service layer (514) provides software services to the computer (502) or other components (whether or not illustrated) that are communicably coupled to the computer (502). The functionality of the computer (502) may be accessible for all service consumers using this service layer. Software services, such as those provided by the service layer (514), provide reusable, defined business functionalities through a defined interface. For example, the interface may be software written in JAVA, C++, or other suitable language providing data in extensible markup language (XML) format or another suitable format. While illustrated as an integrated component of the computer (502), alternative implementations may illustrate the API (512) or the service layer (514) as stand-alone components in relation to other components of the computer (502) or other components (whether or not illustrated) that are communicably coupled to the computer (502). Moreover, any or all parts of the API (512) or the service layer (514) may be implemented as child or sub-modules of another software module, enterprise application, or hardware module without departing from the scope of this disclosure.

The computer (502) includes an interface (506). Although illustrated as a single interface (506) in FIG. 5, two or more interfaces (506) may be used according to particular needs, desires, or particular implementations of the computer (502). The interface (506) is used by the computer (502) for communicating with other systems in a distributed environment that are connected to the network (516). Generally, the interface (506) includes logic encoded in software or hardware (or a combination of software and hardware) and operable to communicate with the network (516). More specifically, the interface (506) may include software supporting one or more communication protocols associated with communications such that the network (516) or interface's hardware is operable to communicate physical signals within and outside of the illustrated computer (502).

The computer (502) includes at least one computer processor (507). Although illustrated as a single computer processor (507) in FIG. 5, two or more processors may be used according to particular needs, desires, or particular implementations of the computer (502). Generally, the computer processor (507) executes instructions and manipulates data to perform the operations of the computer (502) and any algorithms, methods, functions, processes, flows, and procedures as described in the instant disclosure.

The computer (502) also includes a memory (508) that holds data for the computer (502) or other components (or a combination of both) that can be connected to the network (516). For example, memory (508) can be a database storing data consistent with this disclosure. Although illustrated as a single memory (508) in FIG. 5, two or more memories may be used according to particular needs, desires, or particular implementations of the computer (502) and the described functionality. While memory (508) is illustrated as an integral component of the computer (502), in alternative implementations, memory (508) can be external to the computer (502).

The application (510) is an algorithmic software engine providing functionality according to particular needs, desires, or particular implementations of the computer (502), particularly with respect to functionality described in this disclosure. For example, application (510) can serve as one or more components, modules, applications, etc. Further, although illustrated as a single application (510), the application (510) may be implemented as multiple applications (510) on the computer (502). In addition, although illustrated as integral to the computer (502), in alternative implementations, the application (510) can be external to the computer (502).

There may be any number of computers (502) associated with, or external to, a computer system containing computer (502), wherein each computer (502) communicates over network (516). Further, the term “client,” “user,” and other appropriate terminology may be used interchangeably as appropriate without departing from the scope of this disclosure. Moreover, this disclosure contemplates that many users may use one computer (502), or that one user may use multiple computers (502).

FIG. 6 illustrates an example construction system (600) performing a construction operation (630) (e.g., an excavation and/or laying a foundation) based on a construction plan which may be based on a feature such as feature (230) as described in relation to FIG. 1A and/or FIG. 1B. The construction plan (620) may be developed at least in part by a construction planning system (610) in accordance with one or more embodiments. Based upon the disclosure herein, one of ordinary skill in the art will recognize a variety of construction operations and construction systems that may be used in relation to different embodiments and that the illustrated construction system and construction operation performed by the construction system are not meant to be limiting.

Continuing with FIG. 6, FIG. 6 illustrates a side view of one or more construction operations (630) such as an excavation of a construction area (601) and laying a foundation (635). The construction system (600) may include an excavator (640) and/or a cement mixer (650). The excavator (640) may be disposed on the ground surface (118) of the sedimentary basin. The construction area (601) may be a distance away from the outcrop or the outcrop may be formed from exposure due to excavation. The excavator (640) is configured to dig sediment and/or rock out of an excavated area (602). The excavator (640) may include a cab, an arm, and a bucket. The distal end of the arm may be operatively coupled to the bucket. The bucket may include a side cutter for cleanup, digging, and/or levelling the sediments and/or rock. The edge of the side cutter may be straight, wavy (that is, teeth-shape), or a combination of both. The bucket may have different shapes and sizes. Other attachments may also be operatively coupled to the excavator (640) for boring, ripping, crushing, cutting, lifting, and/or other operations at the wellsite. The construction area (601) may be determined using the construction plan which is based on the feature (230). For example, the construction plan may be based on the dip of the basement rock (102). The construction plan may be determined on how deep to dig before contacting the basement rock (102).

In some embodiments, the cement mixer (650) may be disposed on the ground surface (118). The cement mixer (650) may be configured to pour a foundation (635) based on the construction plan (620). The foundation (635) may be reinforced with tie rods (637). Each tie rod may, at least partially, penetrate the basement rock (102). Each tie rod placement and length may be determined based on the feature (230) measured on the surface (100). In some embodiments, the feature (230) may be measured from an existing building, bridge or the like and a remediation operation may be performed based on the construction plan. The remediation operation may include relevelling a foundation of a building or a piling of the bridge.

FIG. 7 shows an example well (700) that may be drilled by an example drilling system (790). The drilling system may include a drilling rig (738) that may perform a drilling operation (795) based on a well drilling plan (780) which may be based on a feature such as the feature (230) as described in relation to FIG. 1A. The well drilling plan (780) may be developed at least in part by a well planning system (770) in accordance with one or more embodiments. Based upon the disclosure herein, one of ordinary skill in the art will recognize a variety of drilling operations and drilling systems that may be used in relation to different embodiments and that the illustrated drilling system and drilling operation performed by the drilling system are not meant to be limiting.

The well planning system (770) may include dedicated software stored on a memory of the computer system (500). The well drilling plan (780) may be informed by the best available information at the time of planning. This may include models encapsulating subterranean stress conditions, the trajectory of any existing wellbores (which may be desirable to avoid), and the existence of other drilling hazards, such as shallow gas pockets, over-pressure zones, and active fault planes. The well drilling plan may also be informed by geologic models encapsulating subterranean structure and drilling targets. Based upon the disclosure herein, one of ordinary skill in the art will recognize a variety of drilling inputs that may be used in relation to different embodiments and that the list of best available information is not meant to be limiting.

Continuing with FIG. 7, a wellbore (709) may be drilled using a drilling system (790) that includes a drilling rig (738) that may be situated on a land drill site, an offshore platform, such as a jack-up rig, a semi-submersible, or a drill ship. The drilling rig (738) may be equipped with a hoisting system, such as a derrick (708), which can raise or lower the drillstring (717) and other tools required to drill the well (700). The drillstring (717) may include one or more drill pipes connected to form conduit and a bottom hole assembly (BHA) (720) disposed at the distal end of the drillstring (717). The BHA (720) may include the drill bit (704) to cut into subsurface rock within a subterranean region of interest (702). The subterranean region of interest (702) may include one or more geologic beds (705, 716). The subterranean region of interest (702) may be offset from the outcrop where a feature, such as feature (230) as described in relation to FIG. 1A, is measured. The feature may be analyzed in relation to one or more geologic boundaries (730) separating one or more geologic beds (705, 716). One of the geologic beds, such as geologic bed (705) may include a drilling target (718). The drilling plan may be designed using a drilling path (703) to intersect the drilling target (718).

In some embodiments, the BHA (720) may further include measurement tools, such as a measurement-while-drilling (MWD) tool and logging-while-drilling (LWD) tool. MWD tools may include sensors and hardware to measure downhole drilling parameters, such as the azimuth and inclination of the drill bit, the weight-on-bit, and the torque. The LWD measurements may include sensors, such as resistivity, gamma ray, and neutron density sensors, to characterize the rock formation surrounding the wellbore (709). Both MWD and LWD measurements may be transmitted to the ground surface (731), such as a ground surface, using any suitable telemetry system, such as mud-pulse or wired-drill pipe, known in the art. The BHA (720) may include a positioning system for communicating positioning and direction of the drill bit relative to the surface location. The positioning system may include gyroscopes, magnetometers, and accelerometers to determine a wellbore's inclination and azimuth while drilling.

To start drilling, or “spudding in” the well, the hoisting system lowers the drillstring (717) suspended from the derrick (708) towards the planned surface location of the wellbore (709). An engine, such as a diesel engine, may be used to supply power to the top drive (710) to rotate the drillstring (717). The weight of the drillstring (717) combined with the rotational motion enables the drill bit (704) to bore the wellbore (709).

The near-surface is typically made up of loose or soft sediment or rock, so large diameter casing (706), e.g., “base pipe” or “conductor casing,” is often put in place while drilling to stabilize and isolate the wellbore (709). At the top of the base pipe is the wellhead, which serves to provide pressure control through a series of spools, valves, or adapters. Once near-surface drilling has begun, water or drill fluid may be used to force the base pipe into place using a pumping system until the wellhead is situated just above the ground surface (731).

Drilling may continue without any casing (706) (i.e., an “open hole” wellbore), once deeper, or more compact rock is reached. While drilling, a drilling mud system (726) may pump drilling mud from a mud tank on the ground surface (731) through the drill pipe. Drilling mud serves various purposes, including pressure equalization, removal of rock cuttings, or drill bit cooling and lubrication.

At planned depth intervals, drilling may be paused and the drillstring (717) withdrawn from the wellbore (709). Sections of casing (706) may be connected and inserted and cemented into the wellbore (709). Casing string or a production liner may be cemented in place by pumping cement and mud (i.e., “cemented liner”), separated by a “cementing plug,” from the ground surface (731) through the drill pipe. The cementing plug and drilling mud force the cement through the drill pipe and into the annular space between the casing (706) and the wellbore wall. Once the cement cures, drilling may recommence. The drilling process is often performed in several stages. Therefore, the drilling and casing cycle may be repeated more than once, depending on the depth of the wellbore (709) and the pressure on the wellbore wall from surrounding rock.

Embodiments of the present disclosure may provide at least one of the following advantages. A feature may be measured from a distance that may be in a difficult to reach area. The methods and systems disclosed herein may be used by geologists and survey and/or civil engineers. The methods and systems disclosed herein may be used to reduce costs and risk to the user to eliminate having to scale buildings and outcrop such as cliffs in order to measure a feature of the outcrop and/or man-made structure. The methods disclosed herein do not require the use of integrated imaging and positioning devices such as an Imaging Total Station, which is more expensive than other total stations as well as not providing adequate resolution of an image. Any kind of laser rangefinders or total stations can be used for the methods disclosed herein thereby reducing cost and minimizing risk to a user in the field.

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims.

What is claimed is:

1. A method for determining a characteristic of a surface, comprising:
calibrating an imaging device to the surface;
capturing a lens distortion parameter from an imaging device;
capturing, using the imaging device, an image of the surface;
displaying the image on a display;
identifying a plurality of tie points on the image;
for each tie point,
capturing a plurality of location coordinates of a point marker located on the surface using a positioning device that is calibrated to the imaging device, and
calculating a plurality of transformation parameters;
identifying an additional point marker located on the surface;
capturing an additional plurality of location coordinates of the additional point marker;
plotting a plot point on the image automatically transformed from the additional point marker using the plurality of transformation parameters; and
calculating a feature of the surface based on the plurality of tie points and the plot point.

2. The method of claim 1, wherein calculating the plurality of transformation parameters comprises calculating the plurality of transformation parameters to transform three-dimensional (3D) coordinates of the surface to two-dimensional (2D) coordinates of the image.

3. The method of claim 2, wherein calculating the plurality of transformation parameters comprises calculating a least-squares solution yielding the plurality of transformation parameters.

4. The method of claim 2, wherein the plurality of transformation parameters comprises a first rotation parameter, a second rotation parameter, a third rotation parameter, a first translation parameter, a second translation parameter, and a third translation parameter.

5. The method of claim 1, wherein calculating the feature of the surface comprises calculating an orientation of the surface.

6. The method of claim 1, wherein calculating the feature of the surface comprises calculating a location of the feature.

7. The method of claim 1, further comprising documenting the feature of the surface in a geospatial database.

8. The method of claim 1, further comprising coloring an area within the image corresponding to the feature of the surface, wherein the surface comprises a geologic layer.

9. The method of claim 1, further comprising calculating a size of the surface from the image using the plurality of tie points and the plot point.

10. The method of claim 9, wherein the size of the surface comprises a volume of the surface.

11. The method of claim 1, further comprising generating a cross-section of the surface automatically based on the feature of the surface.

12. A system for determining a characteristic of a surface, comprising:
an imaging device configured to capture an image of the surface,
wherein the imaging device is calibrated to the surface,
wherein the imaging device comprises a lens and a lens distortion parameter;
a positioning device configured to:
for each tie point,
capture a plurality of location coordinates of a point marker located on the surface using a positioning device that is calibrated to the imaging device, and
capture an additional plurality of location coordinates of an additional point marker; and
a feature analysis system configured to:
display the image,
identify a plurality of tie points on the image,
for each tie point,
calculate a plurality of transformation parameters,
identify an additional point marker located on the surface,
plot a plot point on the image automatically transformed from the additional point marker, and
calculate a feature of the surface based on the plurality of tie points and the plot point.

13. The system of claim 12, wherein the positioning device is a laser range finder.

14. The system of claim 13, wherein the feature analysis system is configured to calculate a least-squares solution to yield the plurality of transformation parameters.

15. The system of claim 13, wherein the plurality of transformation parameters comprises a first rotation parameter, a second rotation parameter, a third rotation parameter, a first translation parameter, a second translation parameter, and a third translation parameter.

16. The system of claim 12, wherein the feature analysis system is configured to calculate the feature of the surface comprises calculating a dip of the surface.

17. The system of claim 12, wherein the feature analysis system is configured to document the feature of the surface in a geospatial database.

18. The system of claim 12, wherein the feature analysis system is configured to color an area within the image corresponding to the feature of the surface, wherein the surface comprises a geologic layer.

19. The system of claim 12, wherein the feature analysis system is configured to calculate a size of the surface from the image.

20. The system of claim 12, wherein the feature analysis system is configured to generate a cross-section of the surface based on the feature of the surface.
